(19) United States
(12) Patent Application Publication
(10) Pub. No.: US 2026/0074197 A1
(43) Pub. Date: Mar. 12, 2026

(54) BATTERY ELECTRODE

(71) Applicant: FORD GLOBAL TECHNOLOGIES, LLC, Dearborn, MI (US)

(72) Inventors: Sookyung JEONG, Northville, MI (US); Eun Young GOH, Northville, MI (US); Keonseok OH, Novi, MI (US); Sangil HAN, Northville, MI (US); Michael LERNER, Corvallis, OR (US); Chi PAIK, Grosse Ile, MI (US)

(21) Appl. No.: 18/827,073

(22) Filed: Sep. 6, 2024

(51) Int. Cl. H01M 4/36; H01M 4/04; H01M 4/38; H01M 4/587; H01M 10/42

(52) U.S. Cl. CPC H01M 4/366; H01M 4/0404; H01M 4/38; H01M 4/587; H01M 10/4235

(57) ABSTRACT

A lithium-ion battery component and method of manufacture are presented. An active material layer with a lithiophilic nitrate compound is mixed with graphite particles and coated onto a current collector. Upon polarization, lithiophilic nanoparticles form on the graphite surfaces, while nitrate anions remain in the electrode structure. The lithiophilic nanoparticles inhibit lithium plating during charging and increase electronic conductivity. The nitrate anions weaken lithium ion solvation in the electrolyte, facilitating faster lithium ion intercalation into the graphite.

### TECHNICAL FIELD

This disclosure relates to materials for lithium-ion batteries.

### BACKGROUND

In lithium-ion batteries, the low equilibrium potential of a graphite anode results in limited overpotential tolerance. This may make the graphite anode prone to the formation of metallic lithium when the potential drops below a threshold during charging, potentially causing lithium plating under high-current charging conditions and at higher states of charge. Various approaches have been proposed to address the challenges of preventing lithium plating and improving reaction kinetics; however, there remains a lack of scalable methods that may be applied in the production of graphite electrodes for fast-charging lithium-ion batteries.

### SUMMARY

A lithium-ion battery component includes a current collector, and an active material layer disposed on the current collector with a lithiophilic nitrate configured to bind with lithium of the active material layer, and induce desolvation of lithium ions to increase intercalation in the active material layer. The lithiophilic nitrate may be silver nitrate, which may be reduced to form silver nanoparticles on surfaces of active material particles in the active material layer. The silver nanoparticles may be configured to inhibit lithium plating during charging. The active material layer may graphite based. Anions of the lithiophilic nitrate may be configured to weaken lithium ion solvation in an electrolyte. Weakened lithium ion solvation may facilitate lithium ion intercalation into the active material layer.

A method of forming a lithium-ion battery component includes mixing a nitrate-containing lithiophilic compound with an active material to form a slurry mixture, coating the slurry mixture onto a current collector to form a wet electrode, drying the wet electrode to form a dry electrode, and polarizing the dry electrode to catalyze a reduction of the nitrate-containing lithiophilic compound and form an electrode. The nitrate-containing lithiophilic compound may be silver nitrate. The active material may include graphite particles. Polarizing the dry electrode reduces the silver nitrate to form silver nanoparticles on surfaces of the graphite particles. A binder of carboxymethyl cellulose may be included in the slurry mixture. Sodium ions from the carboxymethyl cellulose may interact with nitrate anions to form sodium nitrate in the electrode. In some configurations the method may include heat-treating the electrode at a temperature of at least 100° C. to promote formation of silver nitrate from the interaction of sodium ions and nitrate anions.

An electrode includes an electrolyte, and an active material layer containing a nitrate, saturated by the electrolyte to induce desolvation of lithium ions by the nitrate, at a solid electrolyte interphase on a surface of the active material layer The active material layer may include graphite particles. The nitrate may be derived from silver nitrate reduction. Silver nanoparticles may be formed on surfaces of the graphite particles from the silver nitrate reduction. The silver nanoparticles may be configured to increase electronic conductivity of the active material layer and form a solid solution with lithium particles in the active material layer. Anions of the nitrate may be configured to weaken lithium ion solvation in the electrolyte.

### BRIEF DESCRIPTION OF THE DRAWINGS

FIG. 1 is a nyquist plot of the effect of lithiophilic electrolyte additive;

FIG. 2 is a graph of the effect of lithiophilic nitrate additive on capacity retention over a number of cycles;

FIG. 3 is a schematic diagram of the reduction of a nitrate in an active material layer;

FIG. 4 is a schematic diagram of an electrode with nitrate additive;

FIG. 5 is a schematic diagram of a reduction reaction in an electrode with nitrate additive; and

FIG. 6 is a flowchart of a method to form an electrode with nitrate additive.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure introduces an approach to increase the performance of lithium-ion batteries, particularly addressing the challenges associated with fast charging and battery longevity. This approach involves the incorporation of a lithiophilic nitrate compound, with a preference for silver nitrate, into the active material layer of a lithium-ion battery electrode. In a typical implementation, the active material layer includes primarily of graphite particles, which serve as the host for lithium ion intercalation during the charging process. The addition of the lithiophilic nitrate occurs during the electrode manufacturing process, ultimately resulting in the formation of silver nanoparticles on the surfaces of the graphite particles. Concurrently, nitrate anions remain within the electrode structure, playing a role in the increased performance of the battery.

The silver nanoparticles formed on the graphite surfaces contribute to the electrode performance. These nanoparticles, characterized by their high electronic conductivity, increase the overall conductivity of the electrode. The nanoparticles also exhibit a strong affinity for lithium, forming a solid solution that aids in inhibiting lithium plating during high rate charging processes. This inhibition of lithium plating increases the fast-charging capabilities of the battery while maintaining longevity. The nitrate anions that remain in the electrode structure after the reduction of silver ions to silver nanoparticles interact with the electrolyte solution, effectively weakening the solvation shell around the lithium ions. This weakened solvation facilitates easier desolvation of the lithium ions at the electrode-electrolyte interface, which in turn promotes faster intercalation of lithium ions into the graphite structure. The intercalation kinetics directly contribute to the enhanced fast-charging capabilities of the battery.

The manufacturing process for these electrodes involves mixing the active material with the silver nitrate solution to form a slurry. This slurry mixture ensures an even distribution of silver nitrate throughout the graphite material. The slurry is then applied to a current collector, typically copper foil for negative electrodes, using standard coating techniques such as slot-die coating or doctor blade coating. Following the coating process, the electrode undergoes a drying step to remove excess solvents. The dried electrode is then subjected to a polarization step, which is necessary for the in-situ formation of silver nanoparticles. During this step, the silver ions are reduced to metallic silver, forming nanoparticles on the graphite surfaces. This polarization may be achieved during the initial formation cycles of the battery or as a separate step prior to cell assembly. When carboxymethyl cellulose is used as a binder, its sodium ions can interact with the nitrate anions present in the electrode. This interaction may lead to the formation of sodium nitrate within the electrode structure. The presence of sodium nitrate has been observed to increase the cycling performance of the battery.

The performance of these electrodes may be fine-tuned by carefully controlling several parameters. The presence of silver nitrate in the initial slurry mixture determines the density of silver nanoparticles formed on the graphite surfaces. The size and distribution of the silver nanoparticles may be influenced by the polarization conditions, including voltage, current density, and duration. These parameters may be adjusted to achieve the optimal nanoparticle morphology for maximum benefit. While silver nitrate is the lithiophilic nitrate compound of choice, other lithiophilic metal nitrates may also be considered. Alternative compounds may include copper nitrate or nickel nitrate, which may result in the formation of different metal nanoparticles on the graphite surfaces.

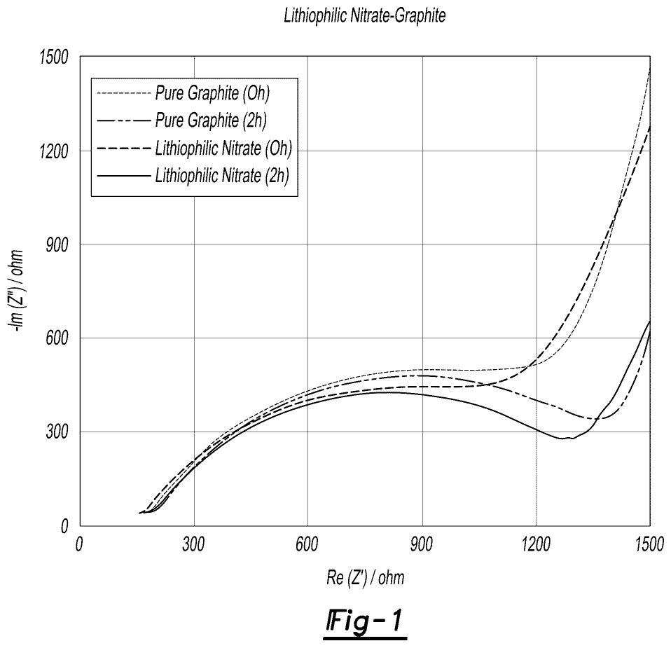

FIG. 1 is a nyquist plot of electrochemical impedance spectroscopy results for lithiophilic nitrate-graphite materials. The graph compares pure graphite and lithiophilic nitrate-treated graphite at 0 hours and 2 hours. The horizontal axis represents the real part of impedance (Re(Z′)), measured in ohm, ranging from 0 to 1500 ohm. The vertical axis shows the negative imaginary part of impedance (−Im(Z″)), also measured in ohm, spanning from 0 to 1500 ohm. Four curves are show of pure graphite and lithiophilic nitrate at both 0 and 2 hours. All curves begin near the origin and extend towards higher impedance values. Initially, the samples behave similarly, but after 2 hours, differences emerge. The pure graphite sample curves suggest an increased overall resistance, while the lithiophilic nitrate sample curves suggest lower overall resistance and potentially increased the rate of electrochemical reaction characteristics. This implies that the lithiophilic nitrate treatment may reduce overall impedance over time, particularly in the mid-frequency range.

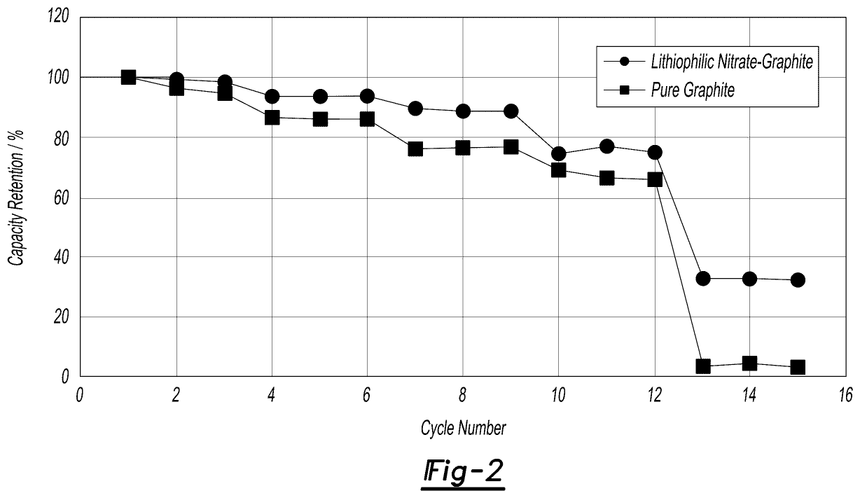

FIG. 2 is a graph comparing the capacity retention performance of pure graphite and lithiophilic nitrate-graphite over multiple charge-discharge cycles. The horizontal axis represents the cycle number, ranging from 0 to 16, while the vertical axis shows the capacity retention as a percentage, spanning from 0% to 120%. Pure graphite (represented by rectangular data points) and lithiophilic nitrate-graphite (represented by circular data points) are both plotted in comparison to one another. Both materials start with nearly 100% capacity retention in the initial cycles. As the cycling progresses, both materials show a gradual decline in capacity retention, but with notable differences in their performance. The lithiophilic nitrate-graphite (circular points) constantly maintains a higher capacity retention compared to pure graphite (rectangular points) throughout the cycling process. Around cycle 10, both materials experience a more significant drop in capacity retention. However, the decline is more pronounced for pure graphite (rectangular points). The most significant difference occurs after cycle 12, where the pure graphite's capacity retention (rectangular points) plummets to near 0%, while the lithiophilic nitrate-graphite (circular points) maintains a capacity retention of approximately 35%. From cycles 12 to 15, the lithiophilic nitrate-graphite (circular points) stabilizes at this 35% capacity retention level, demonstrating substantially superior cycling stability compared to pure graphite (rectangular points), which remains at nearly 0% capacity retention. These results show the beneficial effect of the lithiophilic nitrate treatment on graphite's electrochemical performance, particularly in terms of capacity retention over extended cycling.

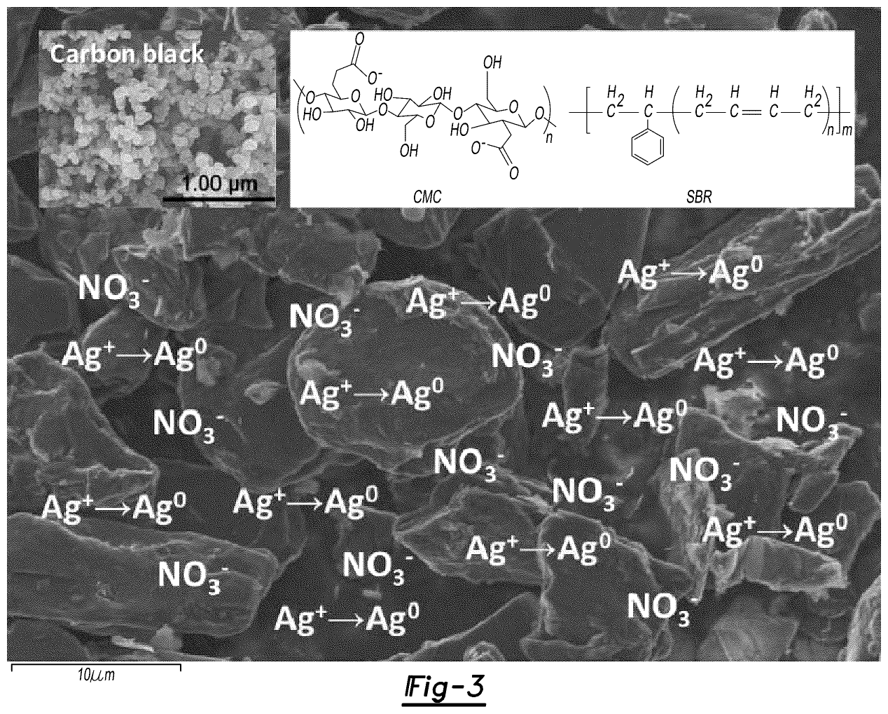

FIG. 3 is a schematic view of the battery electrode material's microstructure and composition. The main image is a scanning electron microscope photograph showing a network of interconnected particles and sheets, representing the carbon-based or graphite material used in the electrode. Superimposed on this image are labels indicating the presence and distribution of nitrate ions scattered throughout the structure, while the process of silver ion reduction to metallic silver is labeled across the surface. An inset electron microscope image labeled “Carbon black,” shows smaller, spherical particles at a higher magnification with a 1.00 micrometer scale bar. The upper right corner includes chemical structure diagrams for carboxymethyl cellulose, and styrene-butadiene rubber. This shows the composition of the electrode material, and how silver ions are reduced to metallic silver throughout the carbon-based structure, while nitrate ions are dispersed within.

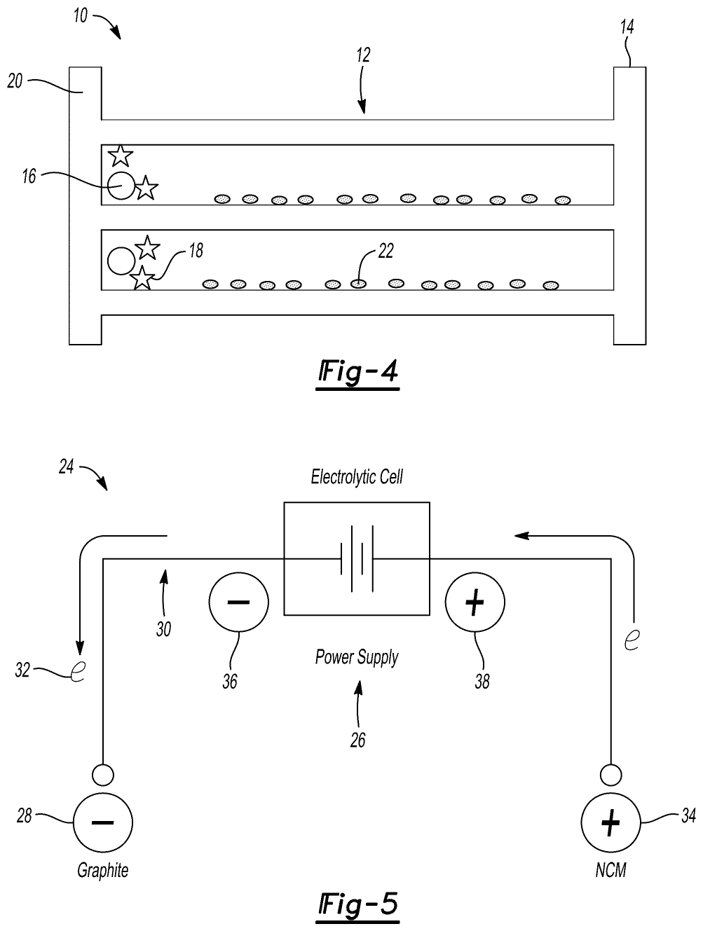

FIG. 4 is a schematic diagram of an electrode 10 with an active material layer 12 on a current collector 14. The active material layer 12 serves as the primary host for electrochemical reactions, supported by the current collector 14 which enables efficient electron transport. Within the active material layer 12, lithium ions 16 move during charge and discharge processes, while nitrate ions 18 are incorporated throughout the active material layer 12. The nitrate ions 18 play a role in modifying a solid electrolyte interface 20, potentially weakening the solvation shell around lithium ions 16 and facilitating their easier movement into and out of the active material layer 12. Nanoparticles 22 enhance the overall conductivity of the electrode 10 and, due to their lithiophilic nature, help create a more uniform distribution of lithium ions 16 during charging. This distribution may significantly reduce the likelihood of lithium plating, especially during fast-charging scenarios. The solid electrolyte interface 20 forms a protective layer on the active material layer 12, mediating interactions between the electrode 10 and other electrolyte components. The solid electrolyte interface 20 plays a role in determining long-term battery stability and performance.

FIG. 5 illustrates is schematic diagram of an electrolytic cell setup 24 to reduce lithiophilic nitrate compounds to form lithiophilic nanoparticles and nitrate ions. A power supply 26 provides the electrical energy required to drive the reduction process. A graphite electrode 28 acts as the anode which is connected by a circuit 30 that facilitates the flow of electrons 32. The electrons 32 flow from a nickel cobalt manganese electrode 34 to the graphite electrode 28. Negative and positive terminals 36, 38 of the power supply 26 establish the potential difference that drives the electrochemical reduction. In the electrolytic cell setup 24 a lithiophilic nitrate is reduced at the graphite electrode 28, forming lithiophilic nanoparticles on a surface of the graphite electrode 28 while generating nitrate ions in an electrolyte.

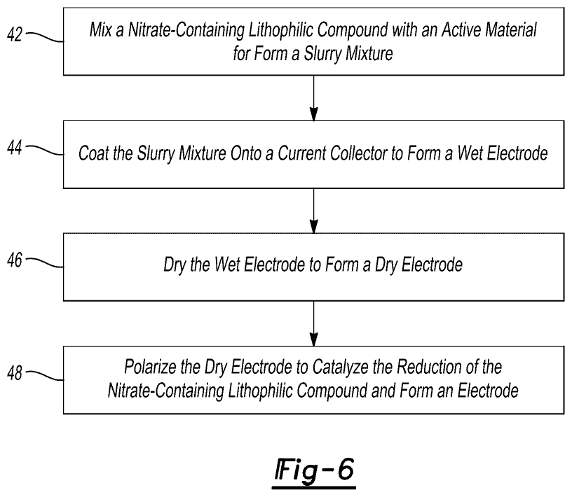

FIG. 6 is a flowchart of a method 40 for forming a lithium-ion battery electrode. In a first step 42, a nitrate-containing lithiophilic compound is mixed with an active material to form a slurry mixture. This is followed by step 44, where the prepared slurry is coated onto a current collector to create a wet electrode. In step 46, the wet electrode is dried to form a dry electrode. In step 48, the dry electrode is polarized to catalyze the reduction of the nitrate-containing lithiophilic compound, forming the finished electrode.

While exemplary embodiments are described above, it is not intended that these embodiments describe all possible forms encompassed by the claims. Moreover, the words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A lithium-ion battery component comprising:
a current collector; and
an active material layer disposed on the current collector with a lithiophilic nitrate configured to bind with lithium of the active material layer, and induce desolvation of lithium ions to increase intercalation in the active material layer.

2. The lithium-ion battery component of claim 1 wherein the lithiophilic nitrate is silver nitrate.

3. The lithium-ion battery component of claim 2 wherein the silver nitrate is reduced to form silver nanoparticles on surfaces of active material particles in the active material layer.

4. The lithium-ion battery component of claim 3 wherein the silver nanoparticles are configured to inhibit lithium plating during charging.

5. The lithium-ion battery component of claim 1 wherein the active material layer is graphite-based.

6. The lithium-ion battery component of claim 1 wherein anions of the lithiophilic nitrate are configured to weaken lithium ion solvation in an electrolyte.

7. The lithium-ion battery component of claim 6 wherein the weakened lithium ion solvation facilitates lithium ion intercalation into the active material layer.

8. A method of forming a lithium-ion battery component comprising:
mixing a nitrate-containing lithiophilic compound with an active material to form a slurry mixture;
coating the slurry mixture onto a current collector to form a wet electrode;
drying the wet electrode to form a dry electrode; and
polarizing the dry electrode to catalyze a reduction of the nitrate-containing lithiophilic compound and form an electrode.

9. The method of claim 8 wherein the nitrate-containing lithiophilic compound is silver nitrate.

10. The method of claim 9 wherein the active material includes graphite particles.

11. The method of claim 10, wherein the polarizing reduces the silver nitrate to form silver nanoparticles on surfaces of the graphite particles.

12. The method of claim 8, further comprising adding a carboxymethyl cellulose to bind to the slurry mixture.

13. The method of claim 12 wherein sodium ions from the carboxymethyl cellulose interact with nitrate anions to form sodium nitrate in the electrode.

14. The method of claim 13, further comprising heat-treating the electrode at a temperature of at least 100° C. to promote formation of silver nitrate from the interaction of sodium ions and nitrate anions.

15. An electrode comprising:
an electrolyte; and
an active material layer containing a nitrate, saturated by the electrolyte to induce desolvation of lithium ions by the nitrate, at a solid electrolyte interphase on a surface of the active material layer.

16. The electrode of claim 15 wherein the active material layer includes graphite particles.

17. The electrode of claim 16 wherein the nitrate is derived from silver nitrate reduction.

18. The electrode of claim 17 wherein silver nanoparticles are formed on surfaces of the graphite particles from the silver nitrate reduction.

19. The electrode of claim 18, wherein the silver nanoparticles are configured to increase electronic conductivity of the active material layer and form a solid solution with lithium particles in the active material layer.

20. The electrode of claim 15 wherein anions of the nitrate are configured to weaken lithium ion solvation in the electrolyte.
